(19) United States
(12) Patent Application Publication
(10) Pub. No.: US 2009/0327065 A1
(43) Pub. Date: Dec. 31, 2009

(54) Systems and Methods for Appending Content to Mobile Messages

(76) Inventor: Amir Mayblum, Walnut Creek, CA (US)

Correspondence Address: SUGHRUE MION, PLLC, 2100 PENNSYLVANIA AVENUE, N.W., SUITE 800, WASHINGTON, DC, 20037, US

(21) Appl. No.: 12/147,446

(22) Filed: Jun. 26, 2008

(51) Int. Cl. G06Q 30/00

(52) U.S. Cl. 705/14.25; 705/10

(57) ABSTRACT

The present invention relates to a system and method for including sponsorship or advertising content in mobile messages by appending a sponsored advertisement to a text or multimedia message sent from one mobile device to another. In one aspect, the content of the advertisement to be appended is selected based upon the content of the mobile message being sent, such as a particular keyword. Additionally, information on the message recipient can be used to select an appropriate message, including stored profile information on the message recipient and volatile information such as the recipient's current location or local time of day. The sponsorship content may be appended to the end of the message so it is easily visible to the recipient.

### BACKGROUND OF THE INVENTION

1. Field of the Invention

The present invention relates to a system and method for appending content to mobile messages, and more specifically to appending a context-based sponsorship message to a text or multimedia message.

2. Background of the Invention

Advertisers are constantly searching for additional ways to present an advertisement to a user. The Internet has proved a significant tool for advertisers looking to present a message to a target audience.

Sponsored services on the Internet are an established industry that is looking to expand. Internet leaders are seeking ways to leverage on their market position into new domains. The mobile domain is considered by many to be the biggest potential and the next logical step.

The mobile advertisement market is beginning to change. Content developers are training their sights on cell phones, which they see as the launch pad for applications targeted at personalized mobile services. New services bring up a whole new set of billing challenges. Advertisement-based revenue provides an opportunity for service providers to put a focus on the end users by providing free services.

Mobile messaging is an integral part of the mobile industry and contributes significantly to the total mobile service revenues of almost every network operator on the planet. During the period 2006-2012, the worldwide mobile subscriber base is expected to increase from 2.65 billion to 4.81 billion. Short Message Service (“SMS”), launched in 1992 in Europe, has proven to be the industry's greatest non-voice success story and by far the most successful data application. Although revenues from voice calls still comprise 80 percent of total mobile service revenues, operators globally are focusing on data services for increasing their average revenue per user (“ARPU”). Of the various data services (such as mobile messaging, mobile gaming, browsing, etc.), mobile messaging has been the frontrunner, with SMS leading the way. Multimedia Messaging Service (“MMS”) has also started experiencing more significant growth in various regions, especially in North America.

Therefore, what is desired is a system and method for advertising in the mobile messaging medium that is easy to implement, does not compromise existing messaging features, and provides relevant advertising content to a subscriber.

### SUMMARY OF THE INVENTION

The present invention relates to a system and method for appending mobile messages with a sponsorship message. The sponsorship message can be appended to any type of mobile message, whether Short Message Service (“SMS”), Multimedia Messaging Service (“MMS”), Instant Messaging (“IM”), E-mail or next generation Mobile Messaging. In one aspect, the content of the sponsorship message is context-based, such that the content is selected based on a characteristic of the message or the subscriber sending or receiving the message.

The present invention also relates to a system for appending a sponsorship message to a mobile message comprising: a receiving message delivery server that receives a mobile message for delivery to a destination and processes the mobile message to determine whether the message will receive a sponsorship message; an advertising gateway that receives the mobile message selected to receive the sponsorship message and forwards the mobile message to receive the sponsorship message; an advertising placement module that appends the sponsorship message to the mobile message to create an appended message; and a sending message delivery server to receive the appended message and deliver the appended message to the destination.

In another aspect, the system further comprises an opt-in database that communicates with the receiving message delivery server to determine whether the message will receive a sponsorship message.

In a further aspect, the system further comprises a subscriber profile database containing profile information about a message recipient, wherein the profile information is used by the advertising placement module to determine an appropriate sponsorship message to append.

In yet another aspect, the system further comprises a mobile network containing volatile information about the message recipient, wherein the volatile information is used by the advertising placement module to determine an appropriate sponsorship message to append.

In a still further aspect, the advertising placement module selects a sponsorship message based upon the content of the mobile message.

In another aspect, the mobile message is a Short Message Service (“SMS”) mobile message.

In yet another aspect, the sending message delivery server is a Short Message Service Center (“SMSC”) server.

In a further aspect, the mobile message is a Multimedia Message Service (“MMS”) mobile message.

In a still further aspect, the sending message delivery server is a Multimedia Message Service Center (“MMSC”) server.

In another aspect of the invention, a method for appending a sponsorship message to a mobile message comprises: receiving a mobile message at a receiving message delivery server for delivery to a destination, and processing the mobile message to determine whether the message will receive a sponsorship message; receiving at an advertising gateway the mobile message selected to receive the sponsorship message, and forwarding the mobile message to receive the sponsorship message; appending the sponsorship message to the mobile message at an advertising placement module to create an appended message; and delivering the appended message to the destination using a sending message delivery server.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 depicts a diagram illustrating the components of a system for appending a sponsorship message to a mobile message, according to one aspect of the present invention; and

FIG. 2 depicts a diagram illustrating a method of appending a sponsorship message to a mobile message, according to one aspect of the present invention.

### DETAILED DESCRIPTION OF THE INVENTION

In the following detailed description, reference will be made to the accompanying drawing(s), in which identical functional elements are designated with like numerals. The aforementioned accompanying drawings show by way of illustration and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The present invention relates to a system and method for appending mobile messages with a sponsorship message. The sponsorship message can be appended to any type of mobile message, whether Short Messaging Service (“SMS”), Multimedia Messaging Service (“MMS”) or other. Mobile messages are intercepted during delivery to allow a message to be appended with a sponsorship message or short tag-line.

In one embodiment, subscribers to a sponsored messaging service will enjoy tariff benefits for person-to-person messaging in exchange for their mobile messages being appended with sponsorship information. Optionally, context sensitive information can be taken into account to provide both the subscriber as well as an advertiser with additional value. Sponsorship information may be included on any mobile message without changing the user equipment (“UE”). The sponsorship message may be included in application-to-person (“A2P”) messages or peer-to-peer (“P2P”) messages.

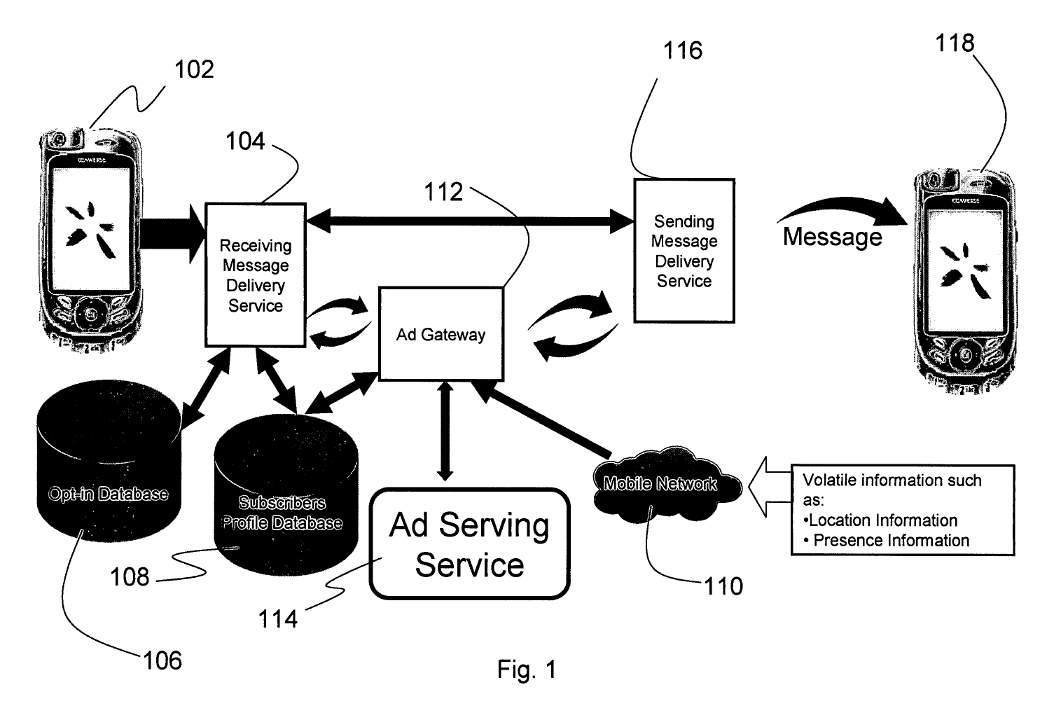

In a first embodiment of a system for appending a sponsored message illustrated in FIG. 1, a first subscriber using a first handset 102 composes and sends a mobile SMS message (not shown) from the handset 102, or originating device, to a Receiving Message Delivery Service (“RMDS”) 104. In one embodiment, the RMDS is a Short Message Service Center (“SMSC”) messaging server. The RMDS 104 obtains information on the destination for the mobile message, including subscriber information on a second subscriber selected by the first subscriber to receive the message. In one embodiment, the RMDS 104 obtains information on the second subscriber from an opt-in database 106 to determine if the second subscriber is eligible to receive a sponsorship message. A subscriber profile database 108 is also present and includes details on the second subscriber, such as the type of handset used or a profile of the second subscriber that will help determine which sponsored message to append. In additional embodiments, ad campaign profiles, a provisioned user list, and billing and usability information are also stored on the subscriber profile database 108. For example, in one particular embodiment, the second subscriber may elect to receive a sponsorship message appended to mobile messages in exchange for a reduced fee from the subscriber's wireless carrier.

Subscriber information may be available depending on the network, and can be organized into two groups. The first group is subscriber specific information, which is pulled off the operator's database such as the subscriber profile database 108, and includes information such as gender, age, type of account (business, private, family), wireless service subscription plan, home or billing address, device type and capabilities, mobile services enrollment and usage patterns. The second group is volatile, or message-related information. This information is volatile in nature, in that it relates only to a specific message sent on the mobile network, and may vary with each message sent, even from the same subscriber. This information is available from the mobile network 110 as illustrated in FIG. 1. An example of the message-related information that may be available on a network include: sender MSISDN (P2P) or source address (A2P), recipient MSISDN, sender's geography (based on MSC Global Title), DCS (“Data Coding Scheme”—required for encoding), length of used text, and message content or text. Sender and recipient location may be available in some networks if location-based services are deployed—for example, via SRI and MSRN information.

Once the RMDS 104 has determined that a subscriber is eligible for sponsored messaging, the message is rerouted to an advertisement gateway 112. If the subscriber is not eligible for an appended message, the RMDS 104 bypasses the ad gateway 112 and sends the message for delivery to a Sending Message Delivery Service (“SMDS”) 116, discussed in more detail below. In one embodiment, a Message Flow Interceptor is embedded in the Messaging Service (SMSC, MMSC, etc.) to intercept an incoming message for ad placement. The advertisement gateway 112 may be implemented internally or externally to the messaging service. The ad gateway 112 implements an interface to an external ad serving service 114 and to the different network components such as the subscriber database 108 and mobile network 110 that will allow pulling user data and message data off the network.

The advertisement gateway 112 obtains subscriber profile information about the recipient subscriber from the subscriber database 108, and then forwards the message to the ad serving service 114, which uses the information obtained by the advertisement gateway 112 to append a sponsorship message to the message and create an appended message. In one aspect, the ad serving service 114 is an external component that is separate from the ad gateway and other system elements, but it is possible to combine the ad serving service 114 with other system components to simplify the system configuration. As an external component, the ad serving service 114 can be a more versatile component that is useful for ad placement in other situations, such as online advertising, and may therefore be advantageous for implementing a single advertisement policy across multiple types of communication protocols and networks.

Once the ad serving service 114 has appended the sponsorship message, the appended message is sent back to the advertisement gateway 112. The advertisement gateway 112 now forwards the appended message to the SMDS 116 for delivery to a recipient subscriber at that subscriber's device, such as a second handset 118. The SMDS 116 may be further defined as a Push Proxy Gateway (“PPG”) server, an SMSC server, a Multimedia Messaging Service Center (“MMSC”) server or a otherwise depending on the type of mobile message being received and sent. For example, an incoming SMS message may be converted to an MMS message by appending a multimedia ad to the message. In this situation, a MMSC server would act as the SMDS 116 to deliver the message over an MMS channel. The SMDS 116 then delivers the appended message with the advertisement to the second handset 118, where a receiving party can open and read the message. The messaging system is also capable of handling other messaging platforms such as instant messaging (“IM”), Enhanced SMS, Instant SMS and Converged Messaging.

In an alternative embodiment, if a message is sent between a first handset 102 and a second handset 118 that are located on the same carrier's network, the RMDS 104 and SMDS 116 may be combined into a single server for performing the receiving and delivery services. Network topology, technology and the number of carriers involved will determine whether a network configuration such as this is possible.

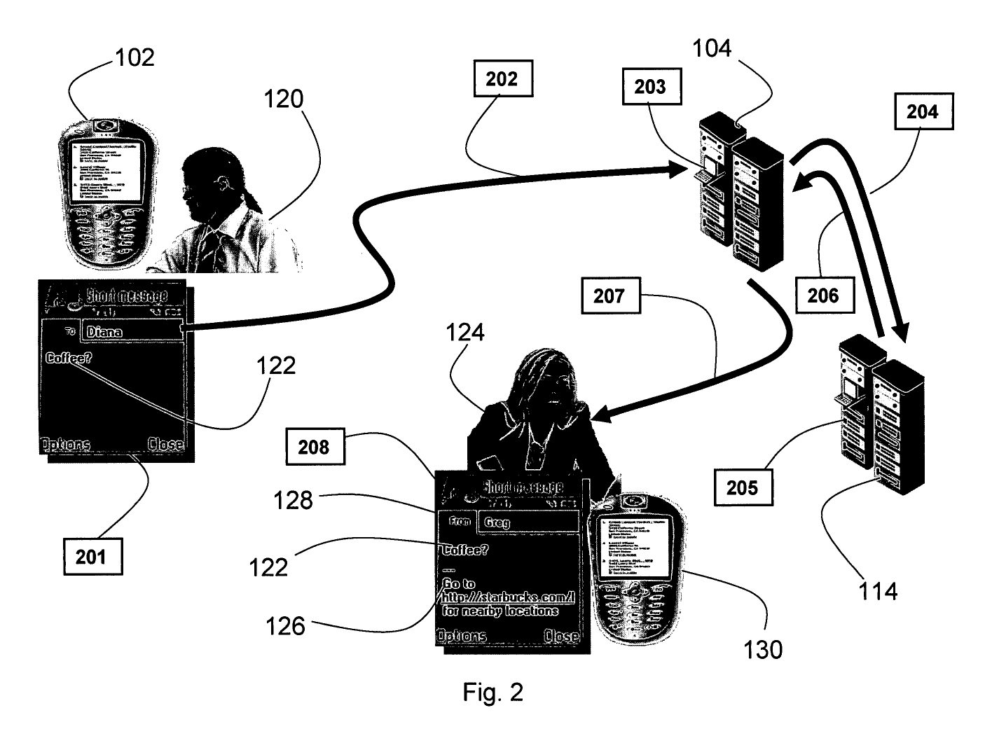

In one embodiment, the content of the sponsorship message is context-based, such that it is selected based on a characteristic of the mobile message. This can be determined by a number of factors related to the message and the subscribers. In one aspect, the system analyzes keywords in the message and appends a sponsorship message that corresponds to the keyword. FIG. 2 illustrates one embodiment of a method of appending a sponsorship message, where a first subscriber Greg 120 first composes (step 201) and sends (step 202) a text message 122 from his handset 102 to a second recipient subscriber Diana 124. The text message 122 reads: “Coffee?,” inviting Diana 124 to meet with Greg 120 for coffee. Once Greg 120 has sent the message 122, Greg's wireless carrier receives the message at a RMDS server 104 and processes the message (step 203). The processing step 203 identifies the destination subscriber, Diana 124, accesses the opt-in database 106 (not shown), then determines whether Diana 124 is a “sponsored messaging” subscriber that is eligible to receive a sponsorship message. The RMDS server 104 then forwards the message 122 to the ad gateway 112 (not shown), which sends the text message 122 to the ad serving service 114 (step 204), as described above with regard to FIG. 1. The ad serving service 114, in this embodiment, analyzes the content of the text message 122 and selects a sponsorship message 126 to be appended to Greg's message (step 205) to create an appended message 128. In this particular embodiment, the ad serving service 114 selects a sponsorship message for a coffee shop. The ad serving service 114 then sends the appended message 128 back to the RMDS 104 through the ad gateway 112 (step 206). The appended message 128, complete with newly-appended sponsorship message 126 for a coffee shop, is now delivered to recipient Diana 130 at her mobile device 130 (step 207). When Diana views the appended message 128 (step 208), she sees the content of the text message 122 from Greg and the sponsorship message 126 for the coffee shop immediately below.

In one aspect, the ad serving service 114 is an online application, such as those operated by search engines to place context-based advertisements next to appropriate searches. Use of an online ad serving service simplifies the system by not requiring setup of a separate advertisement placement application for the mobile messaging field.

In another aspect, the system can be designed so that very short messages will not be appended with a sponsorship message, such as a message that simply reads “ok.” While determining content information of such a short message is likely impractical, a generic sponsorship message, or a sponsorship message selected based on information other than message content, may be selected instead.

In an alternate embodiment, the content of the sponsorship message may be selected based on other characteristics. For example, the characteristics of the wireless subscriber that may be known to the wireless carrier, such as age, gender, music interest, etc. may be collected and used to append appropriate sponsorship messages to messages received by that subscriber. As a further example, if the wireless carrier knows that a user tends to download ringtones, a sponsorship message advertising companies that offer ringtones may be appended to mobile messages received by the subscriber. In additional embodiments, as discussed above, sponsorship messages can also be selected based on the location of the subscriber, the time of day the message is being sent, and other characteristics known to the wireless carrier by obtaining information from the mobile network.

In one aspect, the sponsorship message may be interactive and include a hyperlink to a website related to the advertisement. In the embodiment illustrated in FIG. 2, the sponsorship message 126 for the coffee shop includes a hyperlink to the coffee shop's website.

In an alternate embodiment, the first subscriber may send a mobile message to more than one second subscriber. If the first subscriber uses a different wireless carrier than one or more of the second subscribers, each wireless carrier may have a separate ad serving service. In this embodiment, both the ad serving services of the first subscriber's carrier and the ad serving service of the second subscriber's carrier may have the opportunity to append a sponsorship message to the mobile message before it is delivered to the recipient second subscriber.

Various aspects of the present invention, whether alone or in combination with other aspects of the invention, may be implemented in C++ code running on a computing platform operating in a LSB 2.0 Linux environment. However, aspects of the invention provided herein may be implemented in other programming languages adapted to operate in other operating system environments. Further, methodologies may be implemented in any type of computing platform, including but not limited to, personal computers, mini-computers, main-frames, workstations, networked or distributed computing environments, computer platforms separate, integral to, or in communication with charged particle tools, and the like. Further, aspects of the present invention may be implemented in machine readable code provided in any memory medium, whether removable or integral to the computing platform, such as a hard disc, optical read and/or write storage mediums, RAM, ROM, and the like. Moreover, machine readable code, or portions thereof, may be transmitted over a wired or wireless network.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Although various representative embodiments of this invention have been described above with a certain degree of particularity, those skilled in the art could make numerous alterations to the disclosed embodiments without departing from the spirit or scope of the inventive subject matter set forth in the specification and claims. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention. Also, various aspects and/or components of the described embodiments may be used singly or in any combination in the system for appending content to mobile messages. It is intended that all matter contained in the above description or shown in the accompanying drawings shall be interpreted as illustrative only and not limiting.

What is claimed is:

1. A system for appending a sponsorship message to a mobile message comprising:
a receiving message delivery server that receives a mobile message for delivery to a destination and processes the mobile message to determine whether the message will receive a sponsorship message;
an advertising gateway that receives the mobile message selected to receive the sponsorship message and forwards the mobile message to receive the sponsorship message;
an advertising placement module that appends the sponsorship message to the mobile message to create an appended message; and
a sending message delivery server to receive the appended message and deliver the appended message to the destination.

2. The system of claim 1, further comprising an opt-in database that communicates with the receiving message delivery server to determine whether the message will receive a sponsorship message.

3. The system of claim 1, further comprising a subscriber profile database containing profile information about a message recipient, wherein the profile information is used by the advertising placement module to determine an appropriate sponsorship message to append.

4. The system of claim 1, further comprising a mobile network containing volatile information about the message recipient, wherein the volatile information is used by the advertising placement module to determine an appropriate sponsorship message to append.

5. The system of claim 1, wherein the advertising placement module selects a sponsorship message based upon the content of the mobile message.

6. The system of claim 1, wherein the mobile message is a Short Message Service (“SMS”) mobile message.

7. The system of claim 6, wherein the sending message delivery server is a Short Message Service Center (“SMSC”) server.

8. The system of claim 1, wherein the mobile message is a Multimedia Message Service (“MMS”) mobile message.

9. The system of claim 8, wherein the sending message delivery server is a Multimedia Message Service Center (“MMSC”) server.

10. A method for appending a sponsorship message to a mobile message comprising:
receiving a mobile message at a receiving message delivery server for delivery to a destination, and processing the mobile message to determine whether the message will receive a sponsorship message;
receiving at an advertising gateway the mobile message selected to receive the sponsorship message, and forwarding the mobile message to receive the sponsorship message;
appending the sponsorship message to the mobile message at an advertising placement module to create an appended message; and
delivering the appended message to the destination using a sending message delivery server.

11. The system of claim 10, further comprising communicating with an opt-in database to determine whether the message will receive a sponsorship message.

12. The system of claim 10, further comprising communicating with a subscriber profile database containing profile information about a message recipient to determine an appropriate sponsorship message to append.

13. The system of claim 10, further comprising communicating with a mobile network containing volatile information about the message recipient to determine an appropriate sponsorship message to append.

14. The system of claim 10, further comprising selecting a sponsorship message based upon the content of the mobile message.

15. The system of claim 10, further comprising selecting a Short Message Service (“SMS”) as the mobile message.

16. The system of claim 15, further comprising selecting a Short Message Service Center (“SMSC”) server as the sending message delivery server.

17. The system of claim 10, further comprising selecting a Multimedia Message Service (“MMS”) as the mobile message.

18. The system of claim 17, further comprising selecting a Multimedia Message Service Center (“MMSC”) server as the sending message delivery server.
